(19) United States
(12) Patent Application Publication
(10) Pub. No.: US 2024/0212690 A1
(43) Pub. Date: Jun. 27, 2024

(54) METHOD FOR OUTPUTTING VOICE TRANSCRIPT, VOICE TRANSCRIPT GENERATING SYSTEM, AND COMPUTER-PROGRAM PRODUCT

(71) Applicant: BOE Technology Group Co., Ltd., Beijing (CN)

(72) Inventors: Huiguang Ma, Beijing (CN); Yangyang Zhang, Beijing (CN)

(73) Assignee: BOE Technology Group Co., Ltd., Beijing (CN)

(21) Appl. No.: 17/904,975

(22) PCT Filed: Oct. 28, 2021
(86) PCT No.: PCT/CN2021/127147

§ 371 Date: May 4, 2023

(51) Int. Cl. G10L 17/06; G10L 17/02; G10L 17/04

(52) U.S. Cl. CPC G10L 17/06; G10L 17/02; G10L 17/04

(57) ABSTRACT

A method for outputting a voice transcript is provided. The method includes extracting candidate voiceprint feature information from a candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, storing the candidate voice transcript and a target identifier for the target subject, the target identifier corresponding to the target voiceprint feature information of the target subject.

### TECHNICAL FIELD

The present invention relates to voice recognition technology, more particularly, to a method for outputting a voice transcript, a voice transcript generating system, and a computer-program product.

### BACKGROUND

Organizations frequently held conferences to facilitate communication among their members. It is important to record the speeches made in these conferences in texts, particularly for the keynote speakers. Traditional voice transcription methods do not discern speeches made by the keynote speakers from voices such as background noise or voice made by an attendee of the conference.

### SUMMARY

In one aspect, the present disclosure provides a method for outputting a voice transcript, comprising extracting candidate voiceprint feature information from a candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, storing the candidate voice transcript and a target identifier for the target subject, the target identifier corresponding to the target voiceprint feature information of the target subject.

Optionally, the method further comprises extracting the target voiceprint feature information of the target subject from a voice sample; and storing the target voiceprint feature information of the target subject, the target identifier for the target subject, and correspondence between the target voiceprint feature information of the target subject and the target identifier.

Optionally, the method further comprises reiterating steps of extracting, performing voice recognition, comparing, and storing for at least one additional candidate audio stream; and integrating a plurality of candidate voice transcripts associated with a same target identifier into a meeting record for a same target subject.

Optionally, the method further comprises reiterating steps of transmitting, extracting, performing voice recognition, comparing, and storing for at least one additional candidate audio stream; and integrating a plurality of candidate audio streams associated with a same target identifier into an integrated audio stream associated with the same target identifier.

Optionally, performing voice recognition on the candidate audio stream comprises performing voice recognition on the integrated audio stream associated with the same target identifier to generate a meeting record or a meeting summary for a same target subject.

Optionally, steps of extracting, performing voice recognition, comparing, and storing are performed by a terminal device.

Optionally, the method further comprises transmitting the candidate audio stream from a terminal device to a server; wherein steps of extracting and performing voice recognition are performed by the server.

Optionally, comparing the candidate voiceprint feature information with the target voiceprint feature information of at least one target subject is performed by the server; the target voiceprint feature information of the target subject, the target identifier for the target subject, and the correspondence between the target voiceprint feature information of the target subject and the target identifier are stored on the server; and the candidate voice transcript is stored on the server.

Optionally, the method further comprises transmitting the candidate voice transcript and the target identifier from the server to the terminal device, upon determination that the candidate voiceprint feature information matches with the target voiceprint feature information of the target subject.

Optionally, the method further comprises discarding the candidate voice transcript by the server, upon determination that the candidate voiceprint feature information does not match with target voiceprint feature information of any target subject.

Optionally, comparing the candidate voiceprint feature information with the target voiceprint feature information of at least one target subject is performed by the terminal device; the target voiceprint feature information of the target subject, the target identifier for the target subject, and the correspondence between the target voiceprint feature information of the target subject and the target identifier are stored on the terminal device; the candidate voice transcript is stored on the terminal device; and the method further comprises transmitting the candidate voiceprint feature information and the candidate voice transcript from the server to the terminal device.

Optionally, the method further comprises discarding the candidate voice transcript by the terminal device, upon determination that the candidate voiceprint feature information does not match with target voiceprint feature information of any target subject.

Optionally, the target voiceprint feature information of the target subject, the target identifier for the target subject, and correspondence between the target voiceprint feature information of the target subject and the target identifier are stored on the terminal device; extracting the target voiceprint feature information of the target subject is performed by the server; the method further comprises transmitting the voice sample of the target subject from the terminal device to the server; transmitting the target identifier for the target subject from the terminal device to the server; and transmitting the target voiceprint feature information of the target subject from the server to the terminal device.

Optionally, steps of extracting, comparing, and storing are performed by a terminal device; step of performing voice recognition is performed by a server; the method further comprising transmitting the candidate audio stream from the terminal device to the server; and transmitting the candidate voice transcript from the server to the terminal device.

Optionally, the candidate audio stream is transmitted from the terminal device to the server upon determination that the candidate voiceprint feature information matches with target voiceprint feature information of a target subject; and the server transmits the candidate voice transcript and the target identifier to the terminal device.

Optionally, the method further comprises transmitting the candidate audio stream from a terminal device to a server; wherein step of extracting is performed by the server; step of performing voice recognition and storing are performed by the terminal device.

Optionally, comparing the candidate voiceprint feature information with the target voiceprint feature information of at least one target subject is performed by the server; and the target voiceprint feature information of the target subject, the target identifier for the target subject, and the correspondence between the target voiceprint feature information of the target subject and the target identifier are stored on the server.

Optionally, the method further comprises transmitting a signal from the server to the terminal device indicating that the candidate voiceprint feature information matches with target voiceprint feature information of a target subject; and transmitting a target identifier for the target subject from the server to the terminal device, the target identifier corresponding to the target voiceprint feature information of the target subject.

Optionally, comparing the candidate voiceprint feature information with the target voiceprint feature information of at least one target subject is performed by the terminal device; the target voiceprint feature information of the target subject, the target identifier for the target subject, and the correspondence between the target voiceprint feature information of the target subject and the target identifier are stored on the terminal device; and the method further comprises transmitting the candidate voiceprint feature information from the server to the terminal device.

Optionally, the candidate audio stream transmitted from the terminal device to the server is a fragment of an original candidate audio stream; the original candidate audio stream comprises the candidate audio stream and at least one interval audio stream that is not transmitted to the server; and performing voice recognition on the candidate audio stream comprises performing voice recognition on the original candidate audio stream.

In another aspect, the present disclosure provides a voice transcript generating system, comprising one or more processors configured to extract candidate voiceprint feature information from a candidate audio stream; perform voice recognition on the candidate audio stream to generate a candidate voice transcript; compare the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject.

In another aspect, the present disclosure provides a computer-program product comprising a non-transitory tangible computer-readable medium having computer-readable instructions thereon; wherein the computer-readable instructions are executable by one or more processors to cause the one or more processors to perform extracting candidate voiceprint feature information from the candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating a voice transcript generating system in some embodiments according to the present disclosure.

FIG. 2 is a flow chart illustrating a method for outputting a voice transcript in some embodiments according to the present disclosure.

FIG. 3 is a flow chart illustrating a method of establishing a voiceprint feature recognition model in some embodiments according to the present disclosure.

FIG. 4 is a schematic diagram illustrating an implementation of a voice transcript generating system in some embodiments according to the present disclosure.

FIG. 5 is a flow chart illustrating a method for outputting a voice transcript in some embodiments according to the present disclosure.

FIG. 6 is a flow chart illustrating a method of establishing a voiceprint feature recognition model in some embodiments according to the present disclosure.

FIG. 7 is a flow chart illustrating a method of establishing a voiceprint feature recognition model in some embodiments according to the present disclosure.

FIG. 8 is a flow chart illustrating a method for outputting a voice transcript in some embodiments according to the present disclosure.

FIG. 9 is a flow chart illustrating a method of establishing a voiceprint feature recognition model in some embodiments according to the present disclosure.

FIG. 10 is a flow chart illustrating a method for outputting a voice transcript in some embodiments according to the present disclosure.

FIG. 11 is a flow chart illustrating a method of establishing a voiceprint feature recognition model in some embodiments according to the present disclosure.

FIG. 12 is a flow chart illustrating a method of establishing a voiceprint feature recognition model in some embodiments according to the present disclosure.

FIG. 13 is a flow chart illustrating a method for outputting a voice transcript in some embodiments according to the present disclosure.

FIG. 14 is a flow chart illustrating a method for outputting a voice transcript in some embodiments according to the present disclosure.

FIG. 15 is a flow chart illustrating a method of establishing a voiceprint feature recognition model in some embodiments according to the present disclosure.

FIG. 16 is a flow chart illustrating a method for outputting a voice transcript in some embodiments according to the present disclosure.

FIG. 17 is a flow chart illustrating a method for outputting a voice transcript in some embodiments according to the present disclosure.

FIG. 18 is a flow chart illustrating a method of establishing a voiceprint feature recognition model in some embodiments according to the present disclosure.

FIG. 19 is a flow chart illustrating a method for outputting a voice transcript in some embodiments according to the present disclosure.

FIG. 20 is a flow chart illustrating a method for outputting a voice transcript in some embodiments according to the present disclosure.

FIG. 21 is a flow chart illustrating a method of assigning a target subject in some embodiments according to the present disclosure.

FIG. 22 is a schematic diagram illustrating an implementation of a voice transcript generating system in some embodiments according to the present disclosure.

FIG. 23 is a schematic diagram illustrating an implementation of a voice transcript generating system in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a method for outputting a voice transcript, a voice transcript generating system, and a computer-program product that substantially obviate one or more of the problems due to limitations and disadvantages of the related art. In one aspect, the present disclosure provides a method for outputting a voice transcript. In some embodiments, the method includes extracting candidate voiceprint feature information from the candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, storing the candidate voice transcript and a target identifier for the target subject, the target identifier corresponding to the target voiceprint feature information of the target subject.

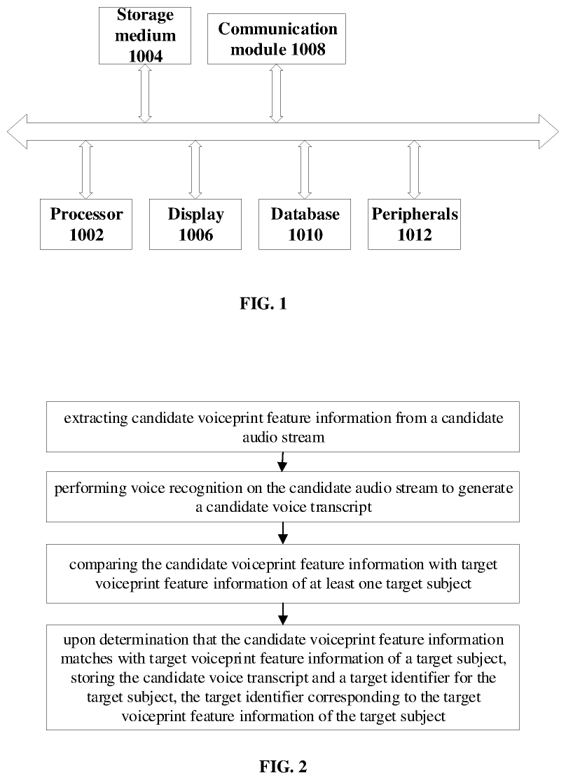

FIG. 1 is a schematic diagram illustrating a voice transcript generating system in some embodiments according to the present disclosure. FIG. 1 shows a voice transcript generating system for implementing the method for outputting a voice transcript in some embodiments according to the present disclosure. Referring to FIG. 1, the voice transcript generating system 1000 may include any appropriate type of TV, such as a plasma TV, a liquid crystal display (LCD) TV, a touch screen TV, a projection TV, a non-smart TV, a smart TV, etc. The voice transcript generating system 1000 may also include other computing systems, such as a personal computer (PC), a tablet or mobile computer, or a smart phone, etc. In addition, the voice transcript generating system 1000 may be any appropriate content-presentation device capable of presenting any appropriate content. Users may interact with the voice transcript generating system 1000 to perform other activities of interest.

As shown in FIG. 1, the voice transcript generating system 1000 may include a processor 1002, a storage medium 1004, a display 1006, a communication module 1008, a database 1010 and peripherals 1012. Certain devices may be omitted, and other devices may be included to better describe the relevant embodiments.

The processor 1002 may include any appropriate processor or processors. Further, the processor 1002 may include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 112 may include various sensors and other I/O devices, such as keyboard and mouse.

All or some of steps of the method, functional modules/units in the system and the device disclosed above may be implemented as software, firmware, hardware, or suitable combinations thereof. In a hardware implementation, a division among functional modules/units mentioned in the above description does not necessarily correspond to the division among physical components. For example, one physical component may have a plurality of functions, or one function or step may be performed by several physical components in cooperation. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable storage medium, which may include a computer storage medium (or a non-transitory medium) and a communication medium (or a transitory medium). The term computer storage medium includes volatile and nonvolatile, removable and non-removable media implemented in any method or technology for storage of information, such as computer readable instructions, data structures, program modules or other data, as is well known to one of ordinary skill in the art. A computer storage medium includes, but is not limited to, RAM, ROM, EEPROM, flash memory or other memory technology, CD-ROM, Digital Versatile Disk (DVD) or other optical disk storage, magnetic cassette, magnetic tape, magnetic disk storage or other magnetic storage device, or any other medium which may be used to store desired information, and which may be accessed by a computer. In addition, a communication medium typically embodies computer readable instructions, data structures, program modules or other data in a modulated data signal such as a carrier wave or other transport mechanism, and includes any information delivery medium, as is well known to one of ordinary skill in the art.

The flowchart and block diagrams in the drawings illustrate architecture, functionality, and operation of possible implementations of a device, a method and a computer program product according to various embodiments of the present disclosure. In this regard, each block in the flowchart or block diagrams may represent a module, program segment(s), or a portion of a code, which includes at least one executable instruction for implementing specified logical function(s). It should also be noted that, in some alternative implementations, functions noted in the blocks may occur out of the order noted in the drawings. For example, two blocks being successively connected may, in fact, be performed substantially concurrently, or the blocks may sometimes be performed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

FIG. 2 is a flow chart illustrating a method for outputting a voice transcript in some embodiments according to the present disclosure. Referring to FIG. 2, the method in some embodiments includes extracting candidate voiceprint feature information from a candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, storing the candidate voice transcript and a target identifier for the target subject, the target identifier corresponding to the target voiceprint feature information of the target subject.

In some embodiments, prior to extracting candidate voiceprint feature information from a candidate audio stream, the method further includes generating the target voiceprint feature information of the target subject, the target identifier for the target subject, and correspondence between the target voiceprint feature information of the target subject and the target identifier. FIG. 3 is a flow chart illustrating a method of establishing a voiceprint feature recognition model in some embodiments according to the present disclosure. Referring to FIG. 3, to generate the target voiceprint feature information of the target subject, the target identifier for the target subject, and correspondence between the target voiceprint feature information of the target subject and the target identifier, the method in some embodiments further includes extracting the target voiceprint feature information of the target subject from a voice sample by the server; and storing the target voiceprint feature information of the target subject, the target identifier for the target subject, and correspondence between the target voiceprint feature information of the target subject and the target identifier.

The target voiceprint feature information of the target subject, the target identifier for the target subject, and the correspondence between the target voiceprint feature information of the target subject and the target identifier may be considered as a voiceprint feature recognition model. When a candidate voiceprint feature information matches with the target voiceprint feature information of a target subject, it is recognized that the speaker (e.g., in a conference) is the target subject. The candidate voice transcript can be immediately associated with a target identifier for the target subject. When the candidate voiceprint feature information does not match with the target voiceprint feature information of a target subject, it is recognized that the speaker is not the target subject, for example, the speaker is an audience of the conference. In this case, the candidate voice transcript needs not be stored, and may be discarded. The present method enables selectively transcribing audio stream of a selected subject (e.g., the target subject), rather than transcribing all audio streams of all speakers.

The voiceprint feature recognition model may be established for at least one target subject. In some embodiments, a plurality of voiceprint feature recognition models may be established for a plurality of target subjects, respectively. In some embodiments, the candidate voiceprint feature information may be compared with target voiceprint feature information in the plurality of voiceprint feature recognition models, respectively. When the candidate voiceprint feature information matches with the target voiceprint feature information of one of the plurality of target subjects, the target identifier for the target subject may be determined based on the correspondence between the target voiceprint feature information of the target subject and the target identifier, and the candidate voice transcript can be immediately associated with the corresponding target identifier.

In some embodiments, the steps depicted in FIG. 2 may be reiterated for at least one additional candidate audio stream, for example, until the conference ends. Accordingly, in some embodiments, a plurality of candidate voice transcripts associated with a same target identifier may be integrated into a meeting record for a same target subject. In some embodiments, a plurality of candidate audio streams associated with a same target identifier may be integrated into an integrated audio stream associated with the same target identifier. Optionally, the method further includes performing voice recognition on the integrated audio stream associated with the same target identifier to generate a meeting record or a meeting summary for a same target subject. The present method enables selectively generating meeting record or meeting summary for a selected subject separately such that the meeting record or meeting summary contained exclusively contents originated from the selected subject.

The meeting record or the meeting summary may be separately generated for each of the plurality of target subjects in case a plurality of voiceprint feature recognition models are established for a plurality of target subjects, respectively. For each of the plurality of target subjects, the meeting record or meeting summary contained exclusively contents originated from the individual subject.

As used herein, the term “meeting” is inclusive of conferences where attendees can participate for communication purpose. The term “meeting” is inclusive of in-person meetings and virtual meetings. Examples of meetings include a teleconference, a videoconference, an in-person class in a classroom, a virtual class, a chat room, a seminar, a discussion among two or more persons, a business meeting, an assembly, a get-together, a gathering.

Voiceprint feature information (e.g., the candidate voiceprint feature information or the target voiceprint feature information) may include various appropriate voiceprint features. Examples of voiceprint features include spectrum, cepstrum, formant, fundamental tone, reflective coefficient, prosody, rhythm, speed, intonation, and volume.

The present method may be practiced using various appropriate implementations. In some embodiments, the method may be implemented by a terminal device. Examples of appropriate terminal devices include a smart phone, a tablet, a notebook, a computer, and an intelligent conference interactive panel. In one example, the terminal device is an intelligent conference interactive panel configured to generate a conference agenda. The terminal device TD may be loaded with various appropriate operating systems such as Android, ios, windows, and Linux. Steps of extracting, performing voice recognition, comparing, and storing are performed by the terminal device. The voiceprint feature recognition model is stored on the terminal device. For example, the voiceprint feature recognition model and the target identifier are stored on the terminal device.

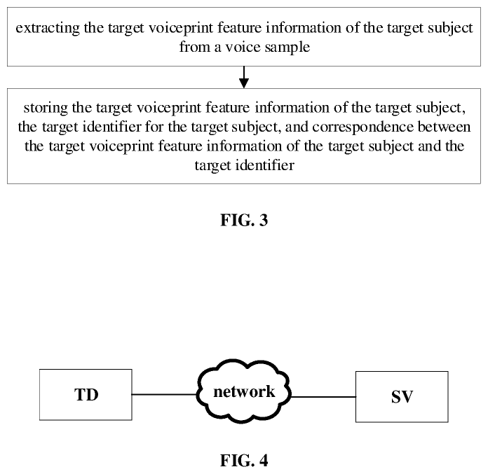

In some embodiments, the method may be implemented at least in part by a server. FIG. 4 is a schematic diagram illustrating an implementation of a voice transcript generating system in some embodiments according to the present disclosure. Referring to FIG. 4, the voice transcript generating system in some embodiments includes a terminal device TD and a server SV, the terminal device TD and the server SV being connected to each other through a network, for example, through a Local Area Network (LAN) or a Wide Area Network (WAN). Optionally, the server SV is a server in the cloud. In one example, the cloud is a public cloud. In another example, the cloud is a private cloud. In another example, the cloud is a hybrid cloud. In some embodiments, the method includes transmitting a candidate audio stream (e.g., from a terminal device TD) to a server SV; and transmitting a voice sample of the target subject (e.g., from the terminal device TD) to the server SV. Optionally, the candidate audio stream and the voice sample of the target subject are collected by the terminal device TD. Steps of extracting and performing voice recognition are performed by the server SV. The steps of comparing and storing may be performed by the server SV or by the terminal device TD. The voiceprint feature recognition model may be stored on the server SV or on the terminal device TD. For example, the voiceprint feature recognition model and the target identifier may be stored on the server SV or on the terminal device TD. The reiterating steps, e.g., for at least one additional candidate audio stream, are also performed accordingly.

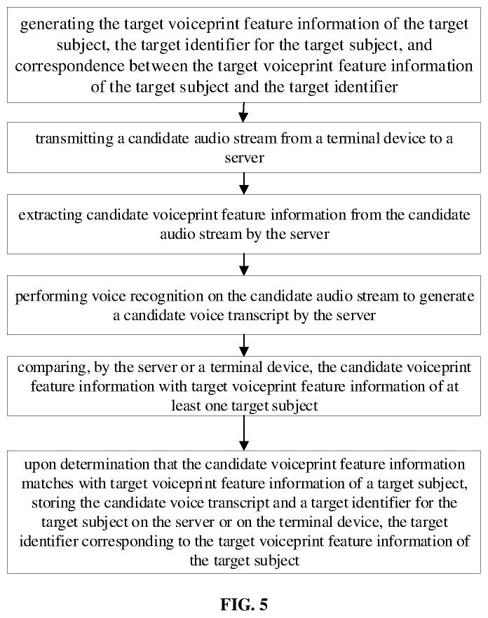

FIG. 5 is a flow chart illustrating a method for outputting a voice transcript in some embodiments according to the present disclosure. Referring to FIG. 5, the method includes transmitting a candidate audio stream from a terminal device to a server; extracting candidate voiceprint feature information from the candidate audio stream by the server; performing voice recognition on the candidate audio stream to generate a candidate voice transcript by the server; comparing, by the server or a terminal device, the candidate voiceprint feature information with target voiceprint feature information of at least one target subject; and upon determination that the candidate voiceprint feature information matches with target voiceprint feature information of a target subject, storing the candidate voice transcript and a target identifier for the target subject on the server or on the terminal device, the target identifier corresponding to the target voiceprint feature information of the target subject.

In some embodiments, referring to FIG. 5, prior to transmitting the candidate audio stream from the terminal device to the server, the method further includes generating the target voiceprint feature information of the target subject, the target identifier for the target subject, and correspondence between the target voiceprint feature information of the target subject and the target identifier. In one example, the generating step is performed by the server.

In some embodiments, subsequent to performing voice recognition on the candidate audio stream to generate the candidate voice transcript by the server, the method further includes transmitting the candidate voice transcript from the server to the terminal device, and displaying the candidate voice transcript on the terminal device, e.g., in real time.

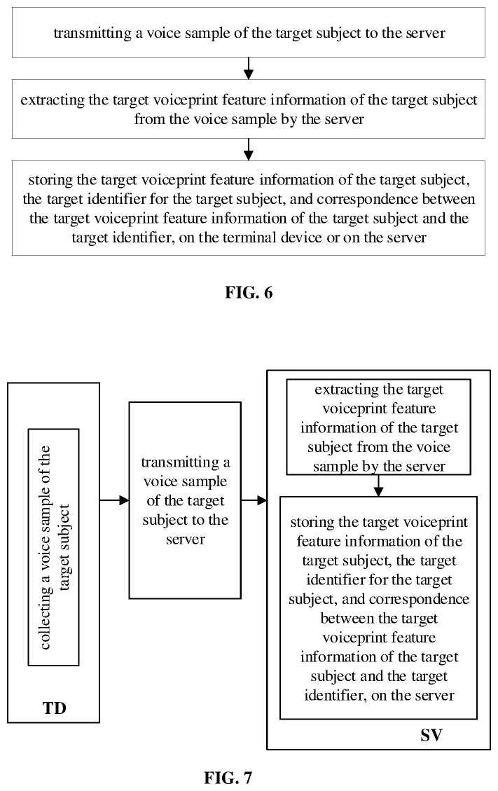

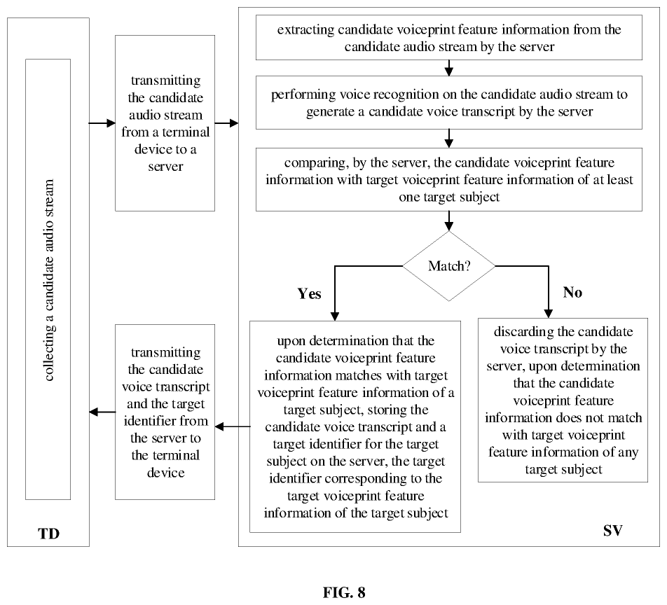

In some embodiments, the generating step is performed by the server. FIG. 6 is a flow chart illustrating a method of establishing a voiceprint feature recognition model in some embodiments according to the present disclosure. Referring to FIG. 6, to generate the target voiceprint feature information of the target subject, the target identifier for the target subject, and correspondence between the target voiceprint feature information of the target subject and the target identifier, the method in some embodiments further includes transmitting a voice sample of the target subject to the server; extracting the target voiceprint feature information of the target subject from the voice sample by the server; and storing the target voiceprint feature information of the target subject, the target identifier for the target subject, and correspondence between the target voiceprint feature information of the target subject and the target identifier, on the terminal device or on the server. The voiceprint feature recognition model may be stored on the terminal device or stored on the server. In one example, the voiceprint feature recognition model is stored on the terminal device. In another example, the voiceprint feature recognition model is stored on the server.

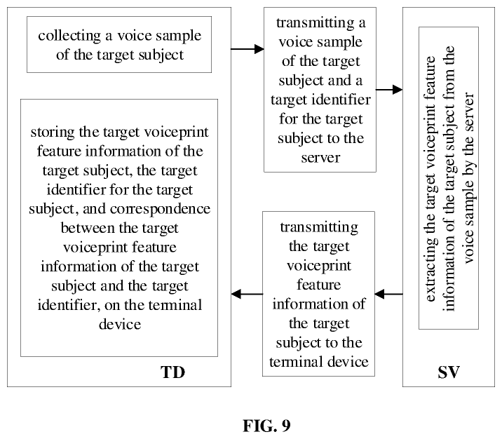

In some embodiments, the voiceprint feature recognition model is stored on the server, and the target identifier is also stored on the server. FIG. 7 is a flow chart illustrating a method of establishing a voiceprint feature recognition model in some embodiments according to the present disclosure. Referring to FIG. 7, the method in some embodiments includes collecting a voice sample of the target subject by the terminal device TD; transmitting the voice sample of the target subject from the terminal device TD to the server SV; extracting the target voiceprint feature information of the target subject from the voice sample by the server SV; and storing the target voiceprint feature information of the target subject, the target identifier for the target subject, and correspondence between the target voiceprint feature information of the target subject and the target identifier, on the server SV.

In some embodiments, the comparing step is performed by the server. When the voiceprint feature recognition model is stored on the server, the step of comparing the candidate voiceprint feature information with the target voiceprint feature information of at least one target subject may be conveniently performed by the server. FIG. 8 is a flow chart illustrating a method for outputting a voice transcript in some embodiments according to the present disclosure. Referring to FIG. 8, the method in some embodiments includes collecting a candidate audio stream by the terminal device TD; transmitting the candidate audio stream from the terminal device TD to a server SV; extracting candidate voiceprint feature information from the candidate audio stream by the server SV; performing voice recognition on the candidate audio stream to generate a candidate voice transcript by the server SV; comparing, by the server SV, the candidate voiceprint feature information with target voiceprint feature information of at least one target subject; and upon determination that the candidate voiceprint feature information matches with target voiceprint feature information of a target subject, storing the candidate voice transcript and a target identifier for the target subject on the server SV, the target identifier corresponding to the target voiceprint feature information of the target subject. In one example as depicted in FIG. 8, the method further includes discarding the candidate voice transcript by the server SV, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the server SV.

Multiple candidate voice transcripts may be generated in a process for outputting a voice transcript. The multiple candidate voice transcripts may correspond to multiple subjects. The candidate voice transcripts corresponding to non-target subjects in some embodiments are discarded, and the candidate voice transcripts corresponding to the target subject are stored.

Moreover, an individual candidate voice transcript may include multiple portions. The multiple portions of the individual candidate voice transcript may correspond to multiple subjects. One or more portions of the individual candidate voice transcript corresponding to non-target subjects in some embodiments are discarded, and one more portions corresponding to the target subject are stored.

In some embodiments, the voiceprint feature recognition model is stored on the terminal device, and the target identifier is also stored on the terminal device. FIG. 9 is a flow chart illustrating a method of establishing a voiceprint feature recognition model in some embodiments according to the present disclosure. Referring to FIG. 9, the method in some embodiments includes collecting a voice sample of the target subject by the terminal device TD; transmitting a voice sample of the target subject and a target identifier for the target subject from the terminal device TD to the server SV; extracting the target voiceprint feature information of the target subject from the voice sample by the server SV; transmitting the target voiceprint feature information of the target subject from the server SV to the terminal device TD; and storing the target voiceprint feature information of the target subject, the target identifier for the target subject, and correspondence between the target voiceprint feature information of the target subject and the target identifier, on the terminal device TD.

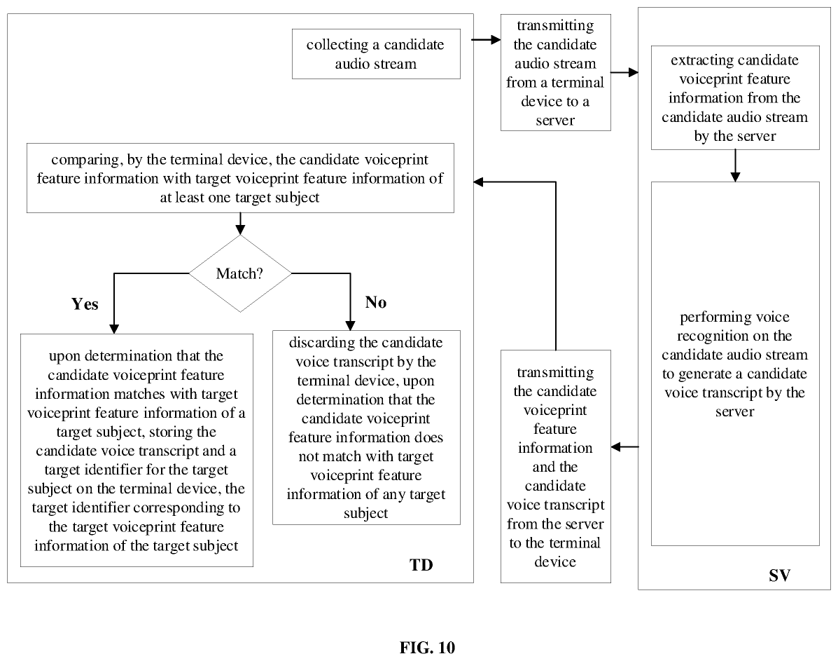

In some embodiments, the comparing step is performed by the terminal device. When the voiceprint feature recognition model is stored on the terminal device, the step of comparing the candidate voiceprint feature information with the target voiceprint feature information of at least one target subject may be conveniently performed by the terminal device. FIG. 10 is a flow chart illustrating a method for outputting a voice transcript in some embodiments according to the present disclosure. Referring to FIG. 10, the method in some embodiments includes collecting a candidate audio stream by the terminal device TD; transmitting the candidate audio stream from a terminal device TD to a server SV; extracting candidate voiceprint feature information from the candidate audio stream by the server SV; performing voice recognition on the candidate audio stream to generate a candidate voice transcript by the server SV; transmitting the candidate voiceprint feature information and the candidate voice transcript from the server SV to the terminal device TD; comparing, by the terminal device TD, the candidate voiceprint feature information with target voiceprint feature information of at least one target subject; and upon determination that the candidate voiceprint feature information matches with target voiceprint feature information of a target subject, storing the candidate voice transcript and a target identifier for the target subject on the terminal device TD, the target identifier corresponding to the target voiceprint feature information of the target subject. In one example as depicted in FIG. 10, the method further includes discarding the candidate voice transcript by the terminal device TD, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the terminal device TD.

Multiple candidate voice transcripts may be generated in a process for outputting a voice transcript. The multiple candidate voice transcripts may correspond to multiple subjects. The candidate voice transcripts corresponding to non-target subjects in some embodiments are discarded, and the candidate voice transcripts corresponding to the target subject are stored.

Moreover, an individual candidate voice transcript may include multiple portions. The multiple portions of the individual candidate voice transcript may correspond to multiple subjects. One or more portions of the individual candidate voice transcript corresponding to non-target subjects in some embodiments are discarded, and one more portions corresponding to the target subject are stored.

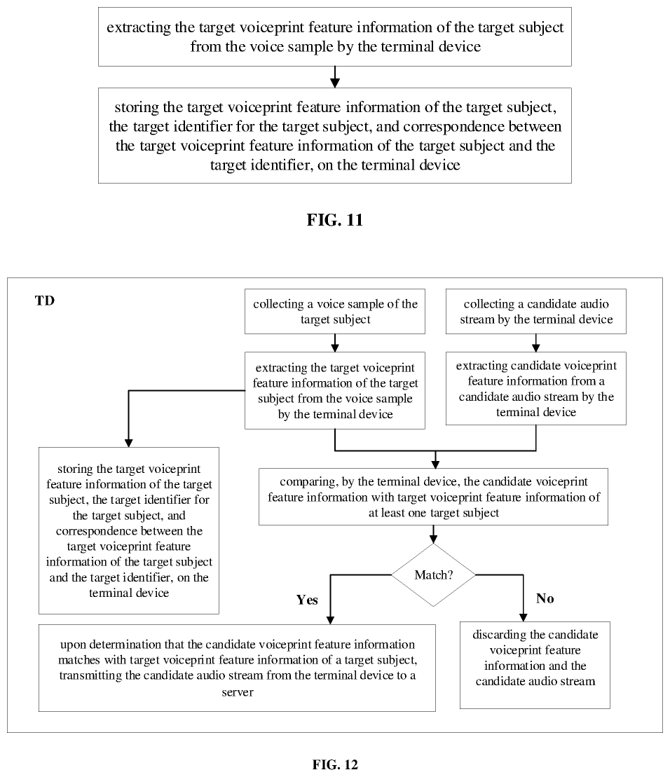

In some embodiments, the method may be implemented partially by a server and partially by a terminal device. In some embodiments, the generating step is performed by the terminal device. FIG. 11 is a flow chart illustrating a method of establishing a voiceprint feature recognition model in some embodiments according to the present disclosure. Referring to FIG. 11, to generate the target voiceprint feature information of the target subject, the target identifier for the target subject, and correspondence between the target voiceprint feature information of the target subject and the target identifier, the method in some embodiments further includes extracting the target voiceprint feature information of the target subject from the voice sample by the terminal device; and storing the target voiceprint feature information of the target subject, the target identifier for the target subject, and correspondence between the target voiceprint feature information of the target subject and the target identifier, on the terminal device. The voiceprint feature recognition model is stored on the terminal device.

In some embodiment, the extracting step and the comparing step are performed by the terminal device. FIG. 12 is a flow chart illustrating a method of establishing a voiceprint feature recognition model in some embodiments according to the present disclosure. Referring to FIG. 12, the method in some embodiments includes collecting a voice sample of the target subject by the terminal device TD; extracting the target voiceprint feature information of the target subject from the voice sample by the terminal device TD; and storing the target voiceprint feature information of the target subject, the target identifier for the target subject, and correspondence between the target voiceprint feature information of the target subject and the target identifier, on the terminal device TD. In some embodiments, the method further includes collecting a candidate audio stream by the terminal device TD; extracting candidate voiceprint feature information from a candidate audio stream by the terminal device TD; and comparing, by the terminal device TD, the candidate voiceprint feature information with target voiceprint feature information of at least one target subject. Optionally, upon determination that the candidate voiceprint feature information matches with target voiceprint feature information of a target subject, the method further includes transmitting the candidate audio stream from the terminal device TD to a server. Optionally, the method further includes storing the candidate voiceprint feature information and the candidate audio stream on the terminal device TD. In one example as depicted in FIG. 12, the method further includes discarding the candidate voiceprint feature information and the candidate audio stream by the terminal device TD, upon determination that the candidate voiceprint feature information does not match with target voiceprint feature information of any target subject. In another example, even if the candidate voiceprint feature information does not match with target voiceprint feature information of any target subject, the candidate voiceprint feature information or the candidate audio stream may be stored, for example, on the terminal device TD.

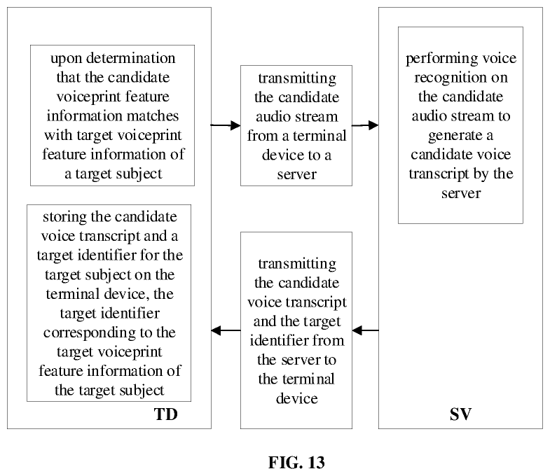

In some embodiment, the voice recognition step is performed by the server. FIG. 13 is a flow chart illustrating a method for outputting a voice transcript in some embodiments according to the present disclosure. Referring to FIG. 13, the method in some embodiments includes, upon determination that the candidate voiceprint feature information matches with target voiceprint feature information of a target subject, transmitting the candidate audio stream from a terminal device TD to a server SV. In some embodiments, the method further includes performing voice recognition on the candidate audio stream to generate a candidate voice transcript by the server SV; and transmitting the candidate voice transcript and the target identifier from the server SV to the terminal device TD.

FIG. 12 and FIG. 13 depict an example in which the candidate audio stream is transmitted from the terminal device TD to the server upon determination that the candidate voiceprint feature information matches with target voiceprint feature information of a target subject. In some embodiments, the candidate audio stream is transmitted from the terminal device to the server whether or not a match is found. In one example, the candidate audio stream is transmitted from the terminal device TD to the server in real time; the server performs voice recognition on the candidate audio stream to generate a candidate voice transcript in real time; the server transmits the candidate voice transcript and the target identifier to the terminal device in real time; and the terminal device displays the candidate voice transcript in real time, whether or not a match is found.

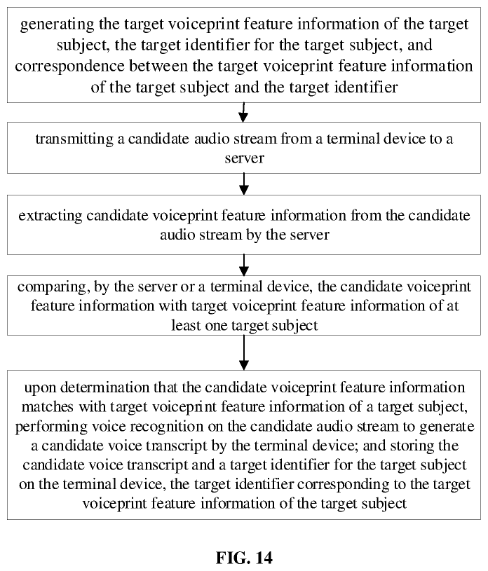

In some embodiments, the method may be implemented partially by a server and partially by a terminal device. In some embodiment, the extracting step is performed by the server, and the voice recognition is performed by the terminal device. FIG. 14 is a flow chart illustrating a method for outputting a voice transcript in some embodiments according to the present disclosure. Referring FIG. 14, the method includes transmitting a candidate audio stream from a terminal device to a server; extracting candidate voiceprint feature information from the candidate audio stream by the server; comparing, by the server or a terminal device, the candidate voiceprint feature information with target voiceprint feature information of at least one target subject; and upon determination that the candidate voiceprint feature information matches with target voiceprint feature information of a target subject, performing voice recognition on the candidate audio stream to generate a candidate voice transcript by the terminal device; and storing the candidate voice transcript and a target identifier for the target subject on the terminal device, the target identifier corresponding to the target voiceprint feature information of the target subject.

In some embodiments, referring to FIG. 14, prior to transmitting the candidate audio stream from the terminal device to the server, the method further includes generating the target voiceprint feature information of the target subject, the target identifier for the target subject, and correspondence between the target voiceprint feature information of the target subject and the target identifier. In one example, the generating step is performed by the server.

In some embodiments, the generating step is performed by the server. To generate the target voiceprint feature information of the target subject, the target identifier for the target subject, and correspondence between the target voiceprint feature information of the target subject and the target identifier, the method in some embodiments further includes transmitting a voice sample of the target subject to the server; extracting the target voiceprint feature information of the target subject from the voice sample by the server; and storing the target voiceprint feature information of the target subject, the target identifier for the target subject, and correspondence between the target voiceprint feature information of the target subject and the target identifier, on the terminal device or on the server. The voiceprint feature recognition model may be stored on the terminal device or stored on the server. In one example, the voiceprint feature recognition model is stored on the terminal device. In another example, the voiceprint feature recognition model is stored on the server.

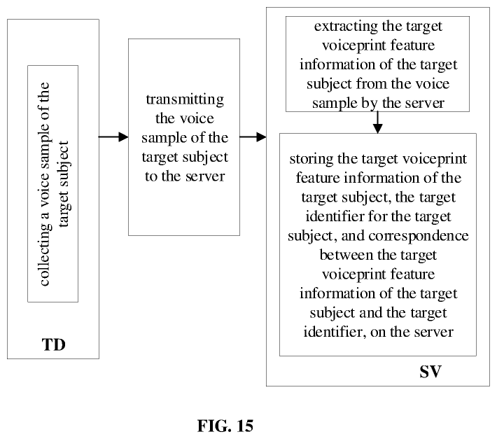

In some embodiments, the voiceprint feature recognition model is stored on the server, and the target identifier is also stored on the server. FIG. 15 is a flow chart illustrating a method of establishing a voiceprint feature recognition model in some embodiments according to the present disclosure. Referring to FIG. 15, the method in some embodiments includes collecting a voice sample of the target subject by the terminal device TD; transmitting the voice sample of the target subject from the terminal device TD to the server SV; extracting the target voiceprint feature information of the target subject from the voice sample by the server SV; and storing the target voiceprint feature information of the target subject, the target identifier for the target subject, and correspondence between the target voiceprint feature information of the target subject and the target identifier, on the server SV.

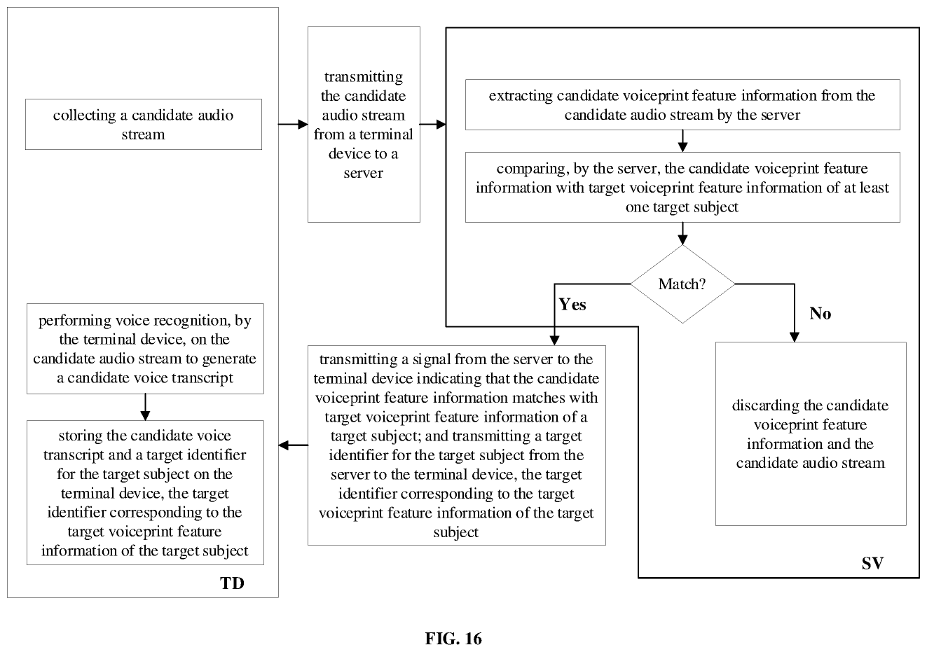

In some embodiments, the comparing step is performed by the server. FIG. 16 is a flow chart illustrating a method for outputting a voice transcript in some embodiments according to the present disclosure. Referring to FIG. 16, the method in some embodiments includes collecting a candidate audio stream by the terminal device TD; transmitting the candidate audio stream from the terminal device TD to a server SV; extracting candidate voiceprint feature information from the candidate audio stream by the server SV; comparing, by the server SV, the candidate voiceprint feature information with target voiceprint feature information of at least one target subject; and upon determination that the candidate voiceprint feature information matches with target voiceprint feature information of a target subject, transmitting a signal from the server SV to the terminal device TD indicating that the candidate voiceprint feature information matches with target voiceprint feature information of a target subject; and transmitting a target identifier for the target subject from the server SV to the terminal device TD, the target identifier corresponding to the target voiceprint feature information of the target subject. In one example as depicted in FIG. 16, the method further includes discarding the candidate voice transcript by the server SV, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the server SV.

In some embodiments, referring to FIG. 16 again, the method further includes performing voice recognition, by the terminal device TD, on the candidate audio stream to generate a candidate voice transcript. The voice recognition step may be performed at any appropriate time. In one example, the voice recognition step is performed by the terminal device TD upon collecting the candidate audio stream. In another example, the voice recognition step is performed by the terminal device TD upon receiving the signal indicating that the candidate voiceprint feature information matches with target voiceprint feature information of a target subject.

In some embodiments, upon receiving, by the terminal device TD, the signal indicating that the candidate voiceprint feature information matches with target voiceprint feature information of a target subject, the method further includes storing the candidate voice transcript and a target identifier for the target subject on the terminal device TD, the target identifier corresponding to the target voiceprint feature information of the target subject.

In one example, upon receiving the signal indicating that the candidate voiceprint feature information does not match with target voiceprint feature information of a target subject, the voice recognition is not performed on the candidate audio stream.

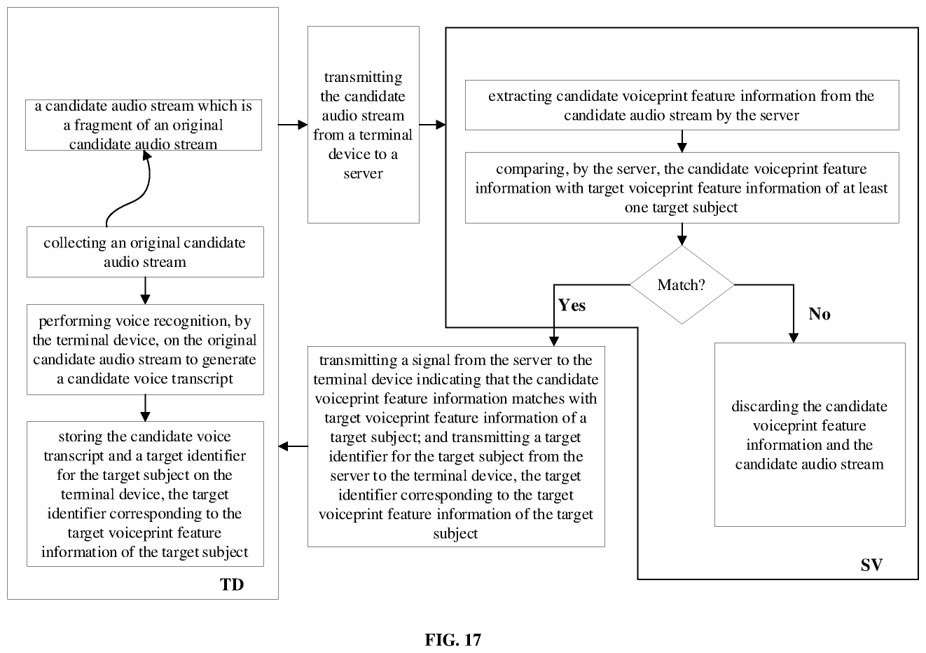

FIG. 17 is a flow chart illustrating a method for outputting a voice transcript in some embodiments according to the present disclosure. The example illustrated in FIG. 17 differs from the example illustrated in FIG. 16 in that the candidate audio stream transmitted from the terminal device to the server in the example illustrated in FIG. 17 is a fragment of an original candidate audio stream. Referring to FIG. 17, the candidate audio stream is transmitted to the server SV. The terminal device TD performs voice recognition on the original candidate audio stream.

By having a candidate audio stream transmitted to the server SV, and the original candidate audio stream used for voice recognition, the present method enables a voice transcript generation process with a high degree of data security. In one example, the candidate audio stream is a fragment of the original candidate audio stream. In one example, the original candidate audio stream includes multiple candidate audio streams that are transmitted to the server SV, and multiple interval audio streams that are not transmitted to the server SV. In another example, the multiple candidate audio streams that are transmitted to the server SV and the multiple interval audio streams that are not transmitted to the server SV are alternately arranged in time. For example, the original candidate audio stream includes -(TAS-NTAS)ₙ-, wherein TAS stands for a respective candidate audio stream that is transmitted to the server SV, NTAS stands for a respective interval audio stream that is not transmitted to the server SV, and n is an integer greater than 1. In one example, the n number of TAS may have a same duration, e.g., 5 seconds. In another example, at least two of the n number of TAS may have different durations. In another example, the n number of NTAS may have a same duration, e.g., 30 seconds. In another example, at least two of the n number of NTAS may have different durations. By only transmitted fragments of the original candidate audio stream to a server (e.g., a public cloud), the security of the data can be significantly improved.

Specifically, referring to FIG. 17, the method in some embodiments includes collecting an original audio stream by the terminal device TD; transmitting the candidate audio stream (which is a fragment of the original audio stream) from the terminal device TD to a server SV; extracting candidate voiceprint feature information from the candidate audio stream by the server SV; comparing, by the server SV, the candidate voiceprint feature information with target voiceprint feature information of at least one target subject; and upon determination that the candidate voiceprint feature information matches with target voiceprint feature information of a target subject, transmitting a signal from the server SV to the terminal device TD indicating that the candidate voiceprint feature information matches with target voiceprint feature information of a target subject; and transmitting a target identifier for the target subject from the server SV to the terminal device TD, the target identifier corresponding to the target voiceprint feature information of the target subject. In one example as depicted in FIG. 16, the method further includes discarding the candidate voice transcript by the server SV, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the server SV.

In some embodiments, referring to FIG. 17, the method further includes performing voice recognition, by the terminal device TD, on the original candidate audio stream to generate a candidate voice transcript. The voice recognition step may be performed at any appropriate time. In one example, the voice recognition step is performed by the terminal device TD upon collecting the original candidate audio stream. In another example, the voice recognition step is performed by the terminal device TD upon receiving the signal indicating that the candidate voiceprint feature information matches with target voiceprint feature information of a target subject.

In some embodiments, upon receiving, by the terminal device TD, the signal indicating that the candidate voiceprint feature information matches with target voiceprint feature information of a target subject, the method further includes storing the candidate voice transcript and a target identifier for the target subject on the terminal device TD, the target identifier corresponding to the target voiceprint feature information of the target subject.

In one example, upon receiving the signal indicating that the candidate voiceprint feature information does not match with target voiceprint feature information of a target subject, the voice recognition is not performed on the original candidate audio stream.

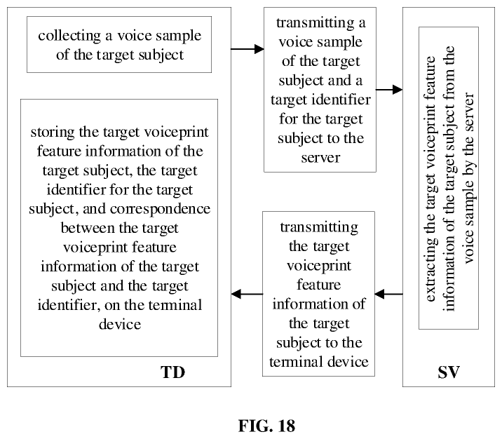

In some embodiments, the voiceprint feature recognition model is stored on the terminal device, and the target identifier is also stored on the terminal device. FIG. 18 is a flow chart illustrating a method of establishing a voiceprint feature recognition model in some embodiments according to the present disclosure. Referring to FIG. 18, the method in some embodiments includes collecting a voice sample of the target subject by the terminal device TD; transmitting a voice sample of the target subject and a target identifier for the target subject from the terminal device TD to the server SV; extracting the target voiceprint feature information of the target subject from the voice sample by the server SV; transmitting the target voiceprint feature information of the target subject from the server SV to the terminal device TD; and storing the target voiceprint feature information of the target subject, the target identifier for the target subject, and correspondence between the target voiceprint feature information of the target subject and the target identifier, on the terminal device TD.

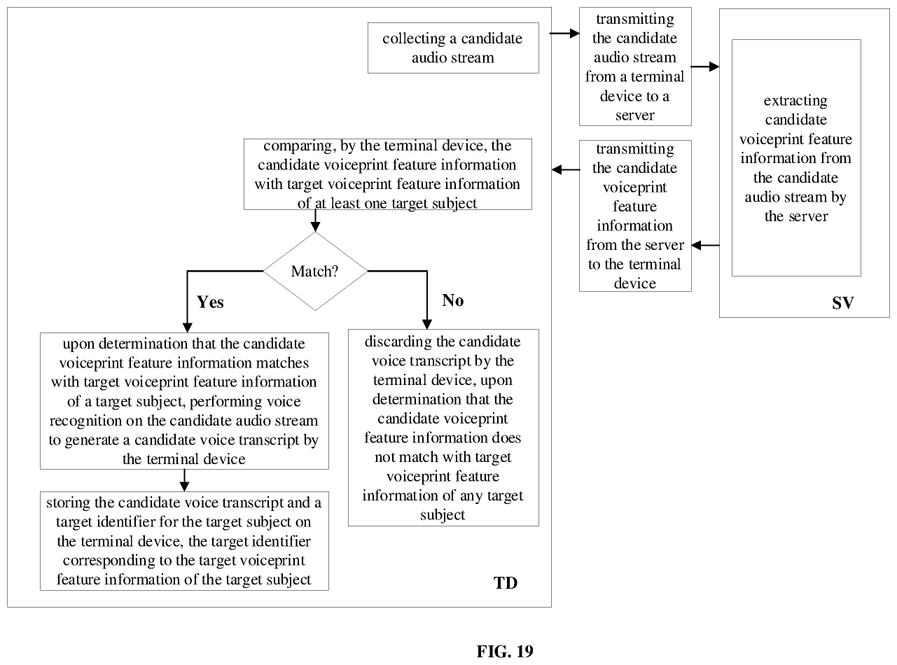

In some embodiments, the comparing step is performed by the terminal device. FIG. 19 is a flow chart illustrating a method for outputting a voice transcript in some embodiments according to the present disclosure. Referring to FIG. 19, the method in some embodiments includes collecting a candidate audio stream by the terminal device TD; transmitting the candidate audio stream from a terminal device TD to a server SV; extracting candidate voiceprint feature information from the candidate audio stream by the server SV; and transmitting the candidate voiceprint feature information from the server SV to the terminal device TD. Upon receiving, by the terminal device TD, the candidate voiceprint feature information from the server SV, the method in some embodiments comparing, by the terminal device TD, the candidate voiceprint feature information with target voiceprint feature information of at least one target subject.

The method in some embodiments further includes performing voice recognition, by the terminal device TD, on the candidate audio stream to generate a candidate voice transcript. The voice recognition step may be performed at any appropriate time. In one example, the voice recognition step is performed by the terminal device TD upon collecting the candidate audio stream. In another example, the voice recognition step is performed by the terminal device TD upon determination that the candidate voiceprint feature information matches with target voiceprint feature information of a target subject.

In some embodiments, upon determination that the candidate voiceprint feature information matches with target voiceprint feature information of a target subject, the method further includes storing the candidate voice transcript and a target identifier for the target subject on the terminal device, the target identifier corresponding to the target voiceprint feature information of the target subject. In one example as depicted in FIG. 19, the method further includes discarding the candidate voice transcript by the terminal device TD, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the terminal device TD.

In another example, upon determination that the candidate voiceprint feature information does not match with target voiceprint feature information of any target subject, the voice recognition is not performed on the candidate audio stream.

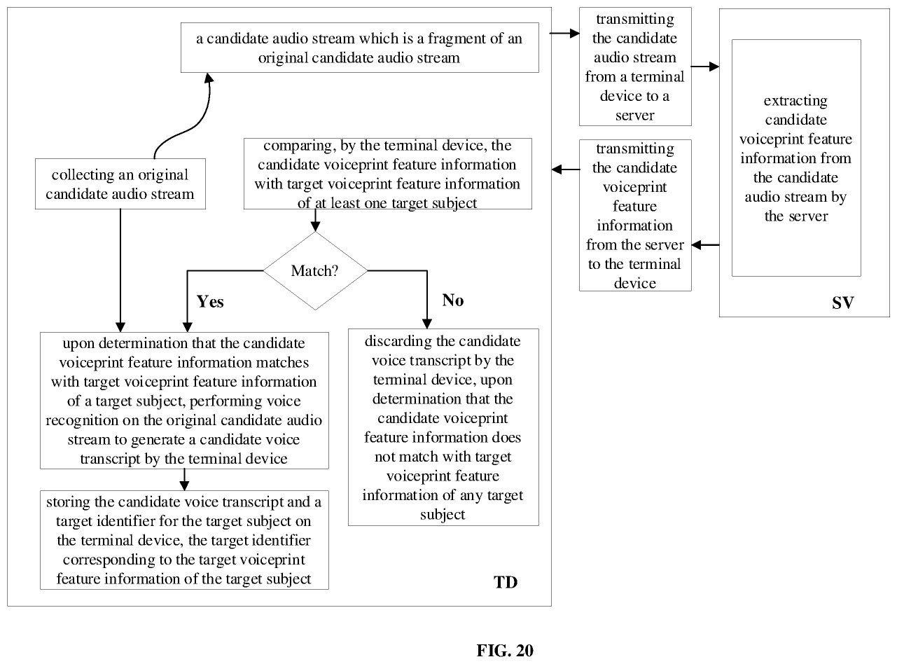

FIG. 20 is a flow chart illustrating a method for outputting a voice transcript in some embodiments according to the present disclosure. The example illustrated in FIG. 20 differs from the example illustrated in FIG. 19 in that the candidate audio stream transmitted from the terminal device to the server in the example illustrated in FIG. 20 is a fragment of an original candidate audio stream. Referring to FIG. 20, the candidate audio stream is transmitted to the server SV. The terminal device TD performs voice recognition on the original candidate audio stream.

By having a candidate audio stream transmitted to the server SV, and the original candidate audio stream used for voice recognition, the present method enables a voice transcript generation process with a high degree of data security. In one example, the candidate audio stream is a fragment of the original candidate audio stream. In one example, the original candidate audio stream includes multiple candidate audio streams that are transmitted to the server SV, and multiple interval audio streams that are not transmitted to the server SV. In another example, the multiple candidate audio streams that are transmitted to the server SV and the multiple interval audio streams that are not transmitted to the server SV are alternately arranged in time. For example, the original candidate audio stream includes -(TAS-NTAS)ₙ-, wherein TAS stands for a respective candidate audio stream that is transmitted to the server SV, NTAS stands for a respective interval audio stream that is not transmitted to the server SV, and n is an integer greater than 1. In one example, the n number of TAS may have a same duration, e.g., 5 seconds. In another example, at least two of the n number of TAS may have different durations. In another example, the n number of NTAS may have a same duration, e.g., 30 seconds. In another example, at least two of the n number of NTAS may have different durations. By only transmitted fragments of the original candidate audio stream to a server (e.g., a public cloud), the security of the data can be significantly improved.

Specifically, referring to FIG. 20, the method in some embodiments includes collecting an original audio stream by the terminal device TD; transmitting the candidate audio stream (which is a fragment of the original audio stream) from a terminal device TD to a server SV; extracting candidate voiceprint feature information from the candidate audio stream by the server SV; and transmitting the candidate voiceprint feature information from the server SV to the terminal device TD. Upon receiving, by the terminal device TD, the candidate voiceprint feature information from the server SV, the method in some embodiments comparing, by the terminal device TD, the candidate voiceprint feature information with target voiceprint feature information of at least one target subject.

The method in some embodiments further includes performing voice recognition, by the terminal device TD, on the original candidate audio stream to generate a candidate voice transcript. The second candidate audio stream comprises the candidate audio stream. The voice recognition step may be performed at any appropriate time. In one example, the voice recognition step is performed by the terminal device TD upon collecting the original candidate audio stream. In another example, the voice recognition step is performed by the terminal device TD upon determination that the candidate voiceprint feature information matches with target voiceprint feature information of a target subject.

In some embodiments, upon determination that the candidate voiceprint feature information matches with target voiceprint feature information of a target subject, the method further includes storing the candidate voice transcript and a target identifier for the target subject on the terminal device, the target identifier corresponding to the target voiceprint feature information of the target subject. In one example as depicted in FIG. 20, the method further includes discarding the candidate voice transcript by the terminal device TD, upon determination that the candidate voiceprint feature information does not match with target voiceprint feature information of any target subject. In another example, even if the candidate voiceprint feature information does not match with target voiceprint feature information of any target subject, the candidate voice transcript may be stored, for example, on the terminal device TD.

In another example, upon determination that the candidate voiceprint feature information does not match with target voiceprint feature information of any target subject, the voice recognition is not performed on the original candidate audio stream.

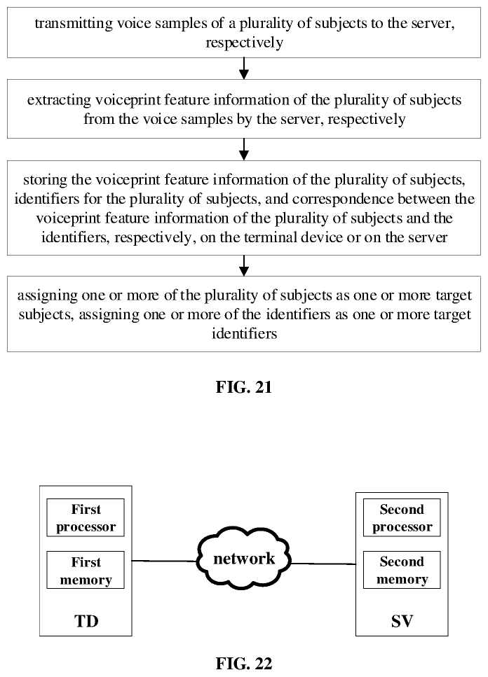

FIG. 21 is a flow chart illustrating a method of assigning a target subject in some embodiments according to the present disclosure. Referring to FIG. 21, the method in some embodiments includes transmitting voice samples of a plurality of subjects to the server, respectively; extracting voiceprint feature information of the plurality of subjects from the voice samples by the server, respectively; storing the voiceprint feature information of the plurality of subjects, identifiers for the plurality of subjects, and correspondence between the voiceprint feature information of the plurality of subjects and the identifiers, respectively, on the terminal device or on the server; and assigning one or more of the plurality of subjects as one or more target subjects, assigning one or more of the identifiers as one or more target identifiers. Optionally, the method further includes assigning one or more of the plurality of subjects as one or more non-target subjects, assigning one or more of the identifiers as one or more non-target identifiers. Optionally, the method includes comparing the candidate voiceprint feature information with the voiceprint feature information of the plurality of subjects. Upon determination that the candidate voiceprint feature information matches with target voiceprint feature information of a target subject of the plurality of subjects, storing the candidate voice transcript and a target identifier for the target subject on the terminal device, the target identifier corresponding to the target voiceprint feature information of the target subject.

In some embodiments, the method further includes displaying, in real time, a result of voice recognition, for example, the candidate voice transcript and the target identifier for the target subject.

Various appropriate voice recognition algorithms may be implemented in the present method. A voice recognition algorithm is implemented to perform a series of processes that extract information (e.g., phonemic and linguistic information) from acoustic information in an audio stream. Examples of voice recognition algorithms include a hidden Markov model algorithm, a neural network algorithm, and a dynamic time warping algorithm.

Various appropriate voiceprint generation and comparison algorithms may be implemented in the present method. Examples of voiceprint generation and comparison algorithms include a hidden Markov model algorithm, a neural network algorithm, a Gaussian Mixture Model, a Universal Background Model, and a dynamic time warping algorithm.

In another aspect, the present disclosure provides a voice transcript generating system. In some embodiments, the voice transcript generating system includes one or more processors configured to extract candidate voiceprint feature information from a candidate audio stream; perform voice recognition on the candidate audio stream to generate a candidate voice transcript; compare the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject.

In some embodiments, the one or more processors are configured to extracting the target voiceprint feature information of the target subject from a voice sample; and storing the target voiceprint feature information of the target subject, the target identifier for the target subject, and correspondence between the target voiceprint feature information of the target subject and the target identifier.

In some embodiments, the one or more processors are configured to reiterate steps of extracting, performing voice recognition, comparing, and storing for at least one additional candidate audio stream; and integrate a plurality of candidate voice transcripts associated with a same target identifier into a meeting record for a same target subject.

In some embodiments, the one or more processors are configured to reiterate steps of transmitting, extracting, performing voice recognition, comparing, and storing for at least one additional candidate audio stream; and integrate a plurality of candidate audio streams associated with a same target identifier into an integrated audio stream associated with the same target identifier.

In some embodiments, the one or more processors are configured to perform voice recognition on the integrated audio stream associated with the same target identifier to generate a meeting record or a meeting summary for a same target subject.

In some embodiments, the voice transcript generating system includes a terminal device comprising at least a first processor. The at least the first processor is configured to extract candidate voiceprint feature information from a candidate audio stream; perform voice recognition on the candidate audio stream to generate a candidate voice transcript; compare the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject.

In some embodiments, the voice transcript generating system includes a terminal device comprising at least a first processor; and a server comprising at least a second processor. The terminal device is configured to transmit the candidate audio stream to the server. The at least the second processor is configured to extract candidate voiceprint feature information from a candidate audio stream; perform voice recognition on the candidate audio stream to generate a candidate voice transcript; compare the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject.

In some embodiments, the at least the second processor is configured to compare the candidate voiceprint feature information with the target voiceprint feature information of at least one target subject. The target voiceprint feature information of the target subject, the target identifier for the target subject, and the correspondence between the target voiceprint feature information of the target subject and the target identifier are stored on the server.

In some embodiments, the server is configured to transmit the candidate voice transcript and the target identifier to the terminal device, upon determination that the candidate voiceprint feature information matches with the target voiceprint feature information of the target subject.

In some embodiments, the at least the second processor is configured to discard the candidate voice transcript, upon determination that the candidate voiceprint feature information does not match with target voiceprint feature information of any target subject.

In some embodiments, the at least the first processor is configured to compare the candidate voiceprint feature information with the target voiceprint feature information of at least one target subject. The target voiceprint feature information of the target subject, the target identifier for the target subject, and the correspondence between the target voiceprint feature information of the target subject and the target identifier are stored on the terminal device. Optionally, the server is configured to transmit the candidate voiceprint feature information and the candidate voice transcript to the terminal device.

In some embodiments, the at least the first processor is configured to discard the candidate voice transcript, upon determination that the candidate voiceprint feature information does not match with target voiceprint feature information of any target subject.

In some embodiments, the target voiceprint feature information of the target subject, the target identifier for the target subject, and correspondence between the target voiceprint feature information of the target subject and the target identifier are stored on the terminal device. Optionally, the terminal device is configured to transmit the voice sample of the target subject to the server; and configured to transmit the target identifier for the target subject to the server. Optionally, the server is configured to transmit the target voiceprint feature information of the target subject to the terminal device.

In some embodiments, the voice transcript generating system includes a terminal device comprising at least a first processor; and a server comprising at least a second processor. The at least the first processor is configured to extract candidate voiceprint feature information from a candidate audio stream; compare the candidate voiceprint feature information with target voiceprint feature information of at least one target subject; and upon determination that the candidate voiceprint feature information matches with target voiceprint feature information of a target subject, store the candidate voice transcript and a target identifier for the target subject, the target identifier corresponding to the target voiceprint feature information of the target subject. The at least the second processor is configured to perform voice recognition on the candidate audio stream to generate a candidate voice transcript. Optionally, the terminal device is configured to, upon determination that the candidate voiceprint feature information matches with target voiceprint feature information of a target subject, transmit the candidate audio stream to the server. Optionally, the server is configured to transmit the candidate voice transcript and the target identifier to the terminal device.

In some embodiments, the voice transcript generating system includes a terminal device comprising at least a first processor; and a server comprising at least a second processor. The terminal device is configured to transmit the candidate audio stream to the server. The at least the first processor is configured to perform voice recognition on the candidate audio stream to generate a candidate voice transcript. The at least the second processor is configured to extract candidate voiceprint feature information from a candidate audio stream; and upon determination that the candidate voiceprint feature information matches with target voiceprint feature information of a target subject, store the candidate voice transcript and a target identifier for the target subject, the target identifier corresponding to the target voiceprint feature information of the target subject.

In some embodiments, the at least the second processor is configured to compare the candidate voiceprint feature information with the target voiceprint feature information of at least one target subject. The target voiceprint feature information of the target subject, the target identifier for the target subject, and the correspondence between the target voiceprint feature information of the target subject and the target identifier are stored on the server.

In some embodiments, the server is configured to transmit a signal to the terminal device indicating that the candidate voiceprint feature information matches with target voiceprint feature information of a target subject; and transmit a target identifier for the target subject from the server to the terminal device, the target identifier corresponding to the target voiceprint feature information of the target subject.

In some embodiments, the at least the first processor is configured to compare the candidate voiceprint feature information with the target voiceprint feature information of at least one target subject is performed by the terminal device. The target voiceprint feature information of the target subject, the target identifier for the target subject, and the correspondence between the target voiceprint feature information of the target subject and the target identifier are stored on the terminal device. The server is configured to transmit the candidate voiceprint feature information to the terminal device.

In some embodiments, the terminal device is configured to collect a second candidate audio stream. Transmitting the candidate audio stream from the terminal device to the server comprises transmitting a fragment of the second candidate audio stream. The second candidate audio stream comprises multiple candidate audio streams that are transmitted to the server, and multiple interval audio streams that are not transmitted to the server. The candidate voice transcript is generated by performing voice recognition on the second candidate audio stream.

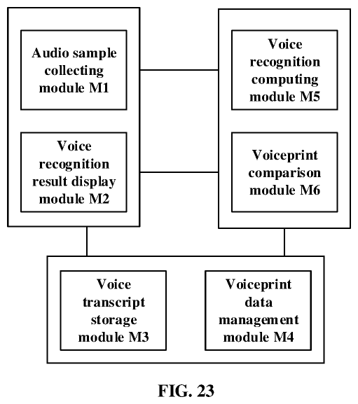

FIG. 22 is a schematic diagram illustrating an implementation of a voice transcript generating system in some embodiments according to the present disclosure. Referring to FIG. 22, in some embodiments, the terminal device TD includes at least a first processor and at least a first memory, and the server SV includes at least a second processor and at least a second memory. In one example, the first memory and the first processor are connected with each other; and the first memory stores computer-executable instructions for controlling the first processor to execute various operations. In another example, the second memory and the second processor are connected with each other; and the second memory stores computer-executable instructions for controlling the second processor to execute various operations. In another example, the server is a server in a distributed computing system comprising one or more networked computers configured to execute in parallel to perform at least one common task; and one or more computer readable storage mediums storing instructions that, when executed by the distributed computing system, cause the distributed computing system to execute software modules.

FIG. 23 is a schematic diagram illustrating an implementation of a voice transcript generating system in some embodiments according to the present disclosure. Referring to FIG. 23, the voice transcript generating system in some embodiments includes an audio sample collecting module M1, a voice recognition result display module M2, a voice transcript storage module M3, a voiceprint data management module M4, a voice recognition computing module M5, and a voiceprint comparison module M6.

The audio sample collecting module M1 is configured to collect an audio sample, such as a voice sample for establishing a voiceprint feature recognition model and a candidate audio stream for comparing voiceprint features. Examples of the audio sample collecting module M1 include a microphone. The audio sample collecting module M1 may be a part of the terminal device, or a stand-alone unit in communication with the terminal device.

The voice recognition result display module M2 is configured to display a result of voice recognition, for example, the candidate voice transcript and the target identifier for the target subject. Examples of the voice recognition result display module M2 include a display panel, e.g., as a part of the terminal device.

The voice transcript storage module M3 is configured to store the candidate voice transcript and the target identifier for the target subject. In one example, the voice transcript storage module M3 is part of the terminal device. In another example, the voice transcript storage module M3 is part of the server.

The voiceprint data management module M4 is configured to manage voiceprint data such as the target voiceprint feature information of the target subject, the target identifier for the target subject, and correspondence between the target voiceprint feature information of the target subject and the target identifier. For example, the voiceprint data management module M4 may be configured to add or delete voiceprint data. In one example, the voiceprint data management module M4 is loaded on the terminal device. In another example, the voiceprint data management module M4 is loaded on the server.

The voice recognition computing module M5 is configured to performing voice recognition on the candidate audio stream to generate a candidate voice transcript. In one example, the voice recognition computing module M5 is loaded on the server. In another example, the voice recognition computing module M5 is one of the software modules in the distributed computing system as discussed above. In another example, the voice recognition computing module M5 is loaded on the terminal device.

The voiceprint comparison module M6 is configured to extracting candidate voiceprint feature information from the candidate audio stream, and/or extracting the target voiceprint feature information of the target subject from the voice sample. In one example, the voiceprint comparison module M6 is loaded on the server. In another example, the voiceprint comparison module M6 is one of the software modules in the distributed computing system as discussed above. In another example, the voiceprint comparison module M6 is loaded on the terminal device.

In another aspect, the present disclosure provides a computer-program product comprising a non-transitory tangible computer-readable medium having computer-readable instructions thereon. In some embodiments, the computer-readable instructions are executable by one or more processors to cause the one or more processors to perform extracting candidate voiceprint feature information from the candidate audio stream; performing voice recognition on the candidate audio stream to generate a candidate voice transcript; comparing the candidate voiceprint feature information with target voiceprint feature information of at least one target subject; and upon determination that the candidate voiceprint feature information matches with target voiceprint feature information of a target subject, storing the candidate voice transcript and a target identifier for the target subject, the target identifier corresponding to the target voiceprint feature information of the target subject.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A method for outputting a voice transcript, comprising:
extracting candidate voiceprint feature information from a candidate audio stream;
performing voice recognition on the candidate audio stream to generate a candidate voice transcript;
comparing the candidate voiceprint feature information with target voiceprint feature information of at least one target subject; and
upon determination that the candidate voiceprint feature information matches with target voiceprint feature information of a target subject, storing the candidate voice transcript and a target identifier for the target subject, the target identifier corresponding to the target voiceprint feature information of the target subject.

2. The method of claim 1, further comprising:
extracting the target voiceprint feature information of the target subject from a voice sample; and
storing the target voiceprint feature information of the target subject, the target identifier for the target subject, and correspondence between the target voiceprint feature information of the target subject and the target identifier.

3. (canceled)

4. (canceled)

5. The method of claim 4, performing voice recognition on the candidate audio stream comprises performing voice recognition on the integrated audio stream associated with the same target identifier to generate a meeting record or a meeting summary for a same target subject.

6. The method of claim 1, wherein steps of extracting, performing voice recognition, comparing, and storing are performed by a terminal device.

7. The method of claim 1, further comprising transmitting the candidate audio stream from a terminal device to a server;
wherein steps of extracting and performing voice recognition are performed by the server.

8. The method of claim 7, wherein comparing the candidate voiceprint feature information with the target voiceprint feature information of at least one target subject is performed by the server;
the target voiceprint feature information of the target subject, the target identifier for the target subject, and the correspondence between the target voiceprint feature information of the target subject and the target identifier are stored on the server; and
the candidate voice transcript is stored on the server.

9. The method of claim 8, further comprising transmitting the candidate voice transcript and the target identifier from the server to the terminal device, upon determination that the candidate voiceprint feature information matches with the target voiceprint feature information of the target subject.

10. The method of claim 8, further comprising discarding the candidate voice transcript by the server, upon determination that the candidate voiceprint feature information does not match with target voiceprint feature information of any target subject.

11. The method of claim 7, wherein comparing the candidate voiceprint feature information with the target voiceprint feature information of at least one target subject is performed by the terminal device;
the target voiceprint feature information of the target subject, the target identifier for the target subject, and the correspondence between the target voiceprint feature information of the target subject and the target identifier are stored on the terminal device;
the candidate voice transcript is stored on the terminal device; and
the method further comprises transmitting the candidate voiceprint feature information and the candidate voice transcript from the server to the terminal device.

12. The method of claim 11, further comprising discarding the candidate voice transcript by the terminal device, upon determination that the candidate voiceprint feature information does not match with target voiceprint feature information of any target subject.

13. The method of claim 2, wherein the target voiceprint feature information of the target subject, the target identifier for the target subject, and correspondence between the target voiceprint feature information of the target subject and the target identifier are stored on the terminal device;
extracting the target voiceprint feature information of the target subject is performed by the server;
the method further comprises:
transmitting the voice sample of the target subject from the terminal device to the server;
transmitting the target identifier for the target subject from the terminal device to the server; and
transmitting the target voiceprint feature information of the target subject from the server to the terminal device.

14. The method of claim 1, wherein steps of extracting, comparing, and storing are performed by a terminal device;
step of performing voice recognition is performed by a server;
the method further comprising:
transmitting the candidate audio stream from the terminal device to the server; and
transmitting the candidate voice transcript from the server to the terminal device.

15. The method of claim 14, wherein the candidate audio stream is transmitted from the terminal device to the server upon determination that the candidate voiceprint feature information matches with target voiceprint feature information of a target subject; and
the server transmits the candidate voice transcript and the target identifier to the terminal device.

16. The method of claim 1, further comprising transmitting the candidate audio stream from a terminal device to a server;
wherein step of extracting is performed by the server;
step of performing voice recognition and storing are performed by the terminal device.

17. The method of claim 16, wherein comparing the candidate voiceprint feature information with the target voiceprint feature information of at least one target subject is performed by the server; and
the target voiceprint feature information of the target subject, the target identifier for the target subject, and the correspondence between the target voiceprint feature information of the target subject and the target identifier are stored on the server.

18. The method of claim 17, further comprising transmitting a signal from the server to the terminal device indicating that the candidate voiceprint feature information matches with target voiceprint feature information of a target subject; and
transmitting a target identifier for the target subject from the server to the terminal device, the target identifier corresponding to the target voiceprint feature information of the target subject.

19. The method of claim 16, wherein comparing the candidate voiceprint feature information with the target voiceprint feature information of at least one target subject is performed by the terminal device;
the target voiceprint feature information of the target subject, the target identifier for the target subject, and the correspondence between the target voiceprint feature information of the target subject and the target identifier are stored on the terminal device; and
the method further comprises transmitting the candidate voiceprint feature information from the server to the terminal device.

20. The method of claim 16, wherein the candidate audio stream transmitted from the terminal device to the server is a fragment of an original candidate audio stream;
the original candidate audio stream comprises the candidate audio stream and at least one interval audio stream that is not transmitted to the server; and
performing voice recognition on the candidate audio stream comprises performing voice recognition on the original candidate audio stream.

21. A voice transcript generating system, comprising:
one or more processors configured to:
extract candidate voiceprint feature information from a candidate audio stream;
perform voice recognition on the candidate audio stream to generate a candidate voice transcript;
compare the candidate voiceprint feature information with target voiceprint feature information of at least one target subject; and
upon determination that the candidate voiceprint feature information matches with target voiceprint feature information of a target subject, store the candidate voice transcript and a target identifier for the target subject, the target identifier corresponding to the target voiceprint feature information of the target subject.

22. A computer-program product comprising a non-transitory tangible computer-readable medium having computer-readable instructions thereon;
wherein the computer-readable instructions are executable by one or more processors to cause the one or more processors to perform:
extracting candidate voiceprint feature information from the candidate audio stream;
performing voice recognition on the candidate audio stream to generate a candidate voice transcript;
comparing the candidate voiceprint feature information with target voiceprint feature information of at least one target subject; and
upon determination that the candidate voiceprint feature information matches with target voiceprint feature information of a target subject, store the candidate voice transcript and a target identifier for the target subject, the target identifier corresponding to the target voiceprint feature information of the target subject.
